(19) United States
(12) Patent Application Publication
(10) Pub. No.: US 2026/0196964 A1
(43) Pub. Date: Jul. 9, 2026

(54) AGRISOLAR AND AGRIVOLTAIC MECHANISMS, SYSTEMS, AND METHODS

(71) Applicant: Robert A. VANDERHYE, McLean, VA (US)

(72) Inventor: Robert A. VANDERHYE, McLean, VA (US)

(21) Appl. No.: 18/831,392

(22) Filed: Jan. 7, 2025

(51) Int. Cl. H02S 30/20; F16M 11/20; H02S 20/10

(52) U.S. Cl. CPC H02S 30/20; F16M 11/2021; H02S 20/10

(57) ABSTRACT

An agrisolar or agrivoltaic system mounts solar panels so that they capture energy from the sun and crops can be grown underneath and adjacent the panels. Each panel is mounted by front and rear support structures which at a lower end of each are supported by or in the ground and at an upper end are mounted by pivotal connections to the back of the solar panel. When it is desired to treat, harvest, or plant crops the rear support structure is detached from the ground and the support structures are pivoted about their pivotal connections to move the solar panel into a substantially vertical out-of-the-way position so that agricultural machinery may move between the solar panels without affecting or being hindered by the solar panels.

### BACKGROUND AND SUMMARY OF THE INVENTION

While some aspects of the invention have broader applicability and can be utilized anywhere that solar panels are desired, the invention primarily relates to agrivoltaics or agrisolar environments.

Both the terms “agrivoltaics” and “agrisolar” relate to recovering useful energy from the sun while simultaneously growing crops but “agrisolar” is a broader term. There are three major types of solar panels, thermal (which recover the sun's heat for useful purposes and can use either liquid, gas, or some other medium to effectively utilize the thermal energy recovered), photovoltaic (which covers all types of cells in panels including, but not limited to, monocrystalline silicon, polycrystalline silicon, thin film, perovskite, organic, and quantum dots), and hybrid (a combination of thermal and photovoltaic). The term “agrisolar” relates to the utilization of all three types of panels while “agrivoltaic” is limited to photovoltaic and hybrid panels. The panels can have any desired configuration including translucent, transparent, semi-transparent, and opaque, and may be rigid or flexible.

Both agrisolar and agrivoltaic systems pair solar energy recovery with agriculture, generating energy and providing space for crops, grazing, and pollinator and native habitats beneath and/or between the solar panels. The use of solar panels in these systems can offer many advantages to plants and animals including partial shade and protection from extreme heat and drought, while evapotranspiration from plants can cool solar panels and thereby improve their energy efficiency.

Classically there are considered to be three main types of agrivoltaic systems: elevated, inter-row, and a combination of the two. Elevated systems place solar panels directly above vegetation, usually elevated by at least about six feet. Elevated systems can protect vegetation from extreme weather such as heavy rains and drought and can reduce sun exposure. In inter-row systems, vegetation is grown between rows of solar panels rather than beneath them. Typically, inter-row systems do not provide the same level of protection against extreme weather but crops usually have more access to direct sunlight than in elevated systems. Rows of panels can be spaced out widely enough to allow tractors and other equipment to plant and cultivate vegetation in between them.

One example of properly supported solar panels in inter-row systems is disclosed in a Jun. 17, 2021 article by Toledo et al in Sustainability, 2021, 13, 6871, https://doi.org/103390/su13126871. There solar panels are securely and permanently mounted by front and rear supports. The panels are spaced far apart so that machinery can move between them and crops are primarily grown in the rows between the panels.

These systems are not ideal for all situations. For example with many inter-row systems, such as described in the Sustainability publication cited above, significant land can be underutilized because of the need to make pathways large enough for tractors or other machinery and the inability to grow plants underneath the panels. Some commercial installations use substantially vertical panels to minimize this problem but such panels are not typically as efficient in capturing solar energy.

To overcome some of the problems mentioned above there are other proposals for efficient agrivoltaic installations. For example, WO2024/047641 describes a system primarily for use in a vineyard which utilizes solar panels pivotally mounted for movement about a horizontal axis at a central location thereof. In an operative position the panels are substantially horizontal or at an angle that allows for effective collection of solar energy. The panels can be pivoted to be substantially vertical in a substantially inoperative position which allows an agricultural machine to move to treat or harvest the crops that normally would be at least partially under the solar panels. Sensors, such as LIDAR or cameras, can be used to sense the position of the machine and power the panels for rotation to their inoperative position. While such systems may be practical for some situations the mounting of the solar panels may not be as robust as necessary or desired given environmental conditions, and complicated and expensive mechanisms are necessary to provide operability of the movement thereof between operative and inoperative positions.

According to the present invention a mechanism, system, and method are provided which are particularly applicable to agrisolar and agrivoltaic situations which allow the solar panels to be securely mounted yet can be movable (e. g. manually) to a position which does not interfere with agricultural equipment. Utilizing the invention it is possible to have essentially an effective agrivoltaic or agrisolar system without requiring large spaces between the solar panels so that more panels and crops can be utilized within a given land area.

According to one aspect of the present invention there is provided a solar mechanism comprising the following components: A solar panel having a first major surface for facing the sun and recovering energy therefrom, a second major surface opposite the first surface; and an elongated top edge in use. A first support structure having opposite first and second ends, and having a first operative length. A first pivotal connection between the first support structure first end and the panel second major surface. A second support structure having opposite first and second ends and having a second operative length greater than the first operative length. A second pivotal connection between the second support structure first end and the panel second major surface; and wherein the second pivotal connection is closer to the top edge than the first pivotal connection.

Desirably the first and second pivotal connections are offset from each other in the dimension of elongation of the top edge (typically substantially horizontal in use) so that they don't interfere with each other when the panel is moved to a substantially vertical position.

The mechanism may further comprise first and second latch elements with the first latch element operatively connected to the solar panel second surface further from the top edge than the first pivotal connection; and wherein the second latch element is operatively connected to the first support structure in cooperating relationship with the first latch element when during use the panel is moved to a substantially vertical position. The latch elements may be magnetic, or any conventional mechanical types such as cam, compression, draw, sliding, spring-loaded, slam, or the like.

A second set of latch elements may also be provided between the second support structure and the second surface of the panel for holding the second support structure in combination with the panel when in a substantially vertical position.

Still further the mechanism may comprise a ground-penetrating and readily removable (from the ground) element at the second support structure second end. This may take the form of a spike. Alternatively an apertured plate could be provided at the second support structure second end and spikes can be pounded through the apertures to hold the plate—and second support structure—in sturdy but removable contact with the ground.

Especially when the solar panel is a photovoltaic panel the first support structure may be tubular; and the first and/or second pivotal connections may comprise a clevis operatively connected to the panel and a pivot pin extending between the clevis and the first end of the tubular first support structure, generally as shown in FIG. 3 of U.S. Pat. No. 9,181,723. Alternatively one or both of the pivotal connections may comprise pivotal components such as shown in US Patent Publication 2015/345545, or GB 1096733.

In agrivoltaic environments the solar panels comprise photovoltaic or hybrid panels.

Desirably the first support structure second end is substantially permanently buried in the ground (as by using a concrete footing) so that only the first operative length thereof extends out of the ground. Also, the second operative length is desirably at least about 10% (e. g. about 15-50%) longer than the first operative length; and the first pivotal connection is spaced at least about 10% (e. g. about 15-50%) further from the top edge than the second pivotal connection is spaced from the top edge.

According to another aspect of the present invention there is provided an agrisolar or agrivoltaic system comprising the following elements: A solar panel having a first major surface facing the sun for recovering energy therefrom, a second major surface opposite the first surface, and an elongated substantially horizontal top edge. A first support structure having opposite first and second ends, and having a first operative length; and wherein the second end of the first support structure is substantially permanently mounted in the ground so that only the first operative length thereof extends above the ground. A first pivotal connection between the first support structure first end and the panel second major surface. A second support structure having opposite first and second ends and having a second operative length greater than the first operative length. A second pivotal connection between the second support structure first end and the panel second major surface. Wherein the second support structure is removably (e. g. manually) operatively connected to the ground (mounted by or in the ground); and wherein the second pivotal connection is closer to the top edge than the first pivotal connection is so that when the second support structure second end is moved upwardly the first and second support structures pivot about the first and second pivotal connections so that the solar panel moves to a substantially vertical orientation. And, crops in the ground beneath the solar panel and adjacent the first and second support structures when the second support structure second end is supported by the ground.

The crops may be any crops suitable for agrivoltaic systems including, but not limited to, grapes, berries, grasses, grains, hardy vegetables (e.g. kale and broccoli), root vegetables (e. g. potatoes, garlic, and carrots), leafy greens (e. g. lettuce, cabbage, and spinach), and/or flowers that support beekeeping. The panels need not be elevated to six feet, but can be shorter (e. g. two-four feet).

The agrisolar or agrivoltaic system as described may also utilize the latch elements, pivotal systems, and an offset between the pivotal connections as described above.

According to yet another aspect of the invention there is provided a method of providing and operating an agrisolar or agrivoltaic system such as described above. The method may comprise: a) mounting the second support structure second end so that it is removably supported by the ground so that the system is stable under normal environmental conditions; and b) occasionally removing (e. g. manually) the second end of the second support structure from the ground and then moving the second support structure upwardly so that the panel is moved to a substantially vertical position.

The method may further comprise c) running agricultural machinery to treat, harvest, or re-plant the crops after the practice of b) when the panels are in a substantially vertical position. After treatment or harvesting (or subsequent planting) the method may further comprise d) returning the second support structure to its ground supported position.

Procedure b) may be practiced at least in part by operatively connecting a hydraulic or pneumatic jack to the second support structure and operating the jack.

It is the primary object of the present invention to provide a solar panel mounting mechanism that is highly functional and especially advantageous when used in agrisolar and agrivoltaic systems, and a method of utilization thereof. This and other objects of the invention will be apparent from the detailed description of the drawings and the appended claims.

### BRIEF DESCRIPTION OF THE DRAWINGS

FIG. 1 is a schematic side view of a conventional prior art inter-row agrivoltaic system over which the invention is an improvement;

FIG. 2 is view like that of FIG. 1 utilizing the advantageous system according to the invention;

FIG. 3 is a schematic side view of one of the solar panel mechanisms as illustrated in FIG. 2 when operated upon so that the solar panel is in a substantially vertical position;

FIG. 4 is a schematic rear view of one of the solar panel mechanisms of FIG. 2; and

FIG. 5 is an elevational view of the configuration that an exemplary pivotal connection may take according to the present invention.

### DETAILED DESCRIPTION OF THE DRAWINGS

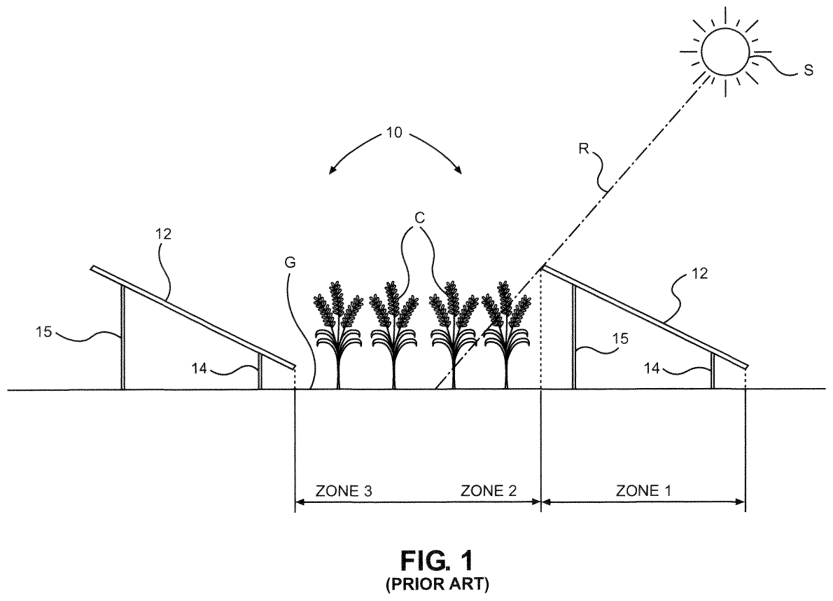

FIG. 1 is a schematic illustration of a prior art inter-row agrivoltaic system 10 such as shown in the Toledo et al Sustainability publication cited in the Background and Summary of the Invention. The system comprises a plurality of photovoltaic solar panels 12 each of which is securely mounted on the ground G so that during daylight hours the panels 12 receive solar radiation R from the sun S. Each panel 12 is securely mounted by at least one front vertical support 14 and at least one longer rear support 15 so that the panel 12 is at an angle desirable for efficiently receiving solar radiation R. Crops C grow in the rows between the panels 12, the rows being sufficiently wide to accommodate agricultural equipment for treating, harvesting, or re-planting the crops C when passing between the panels 12.

While the prior art system 10 is highly desirable it can have the disadvantages of hindering equipment that desirably treats or harvests the crops C underneath the panels 12 so that normally it is impractical to grow crops under the panels 12. If no crops C are planted underneath the panels 12 then arable land is not used optimally. Also, in order to accommodate agricultural equipment the system 10 of FIG. 1 requires significant spacing between the panels 12 which can also result is less than optimal utilization of arable land.

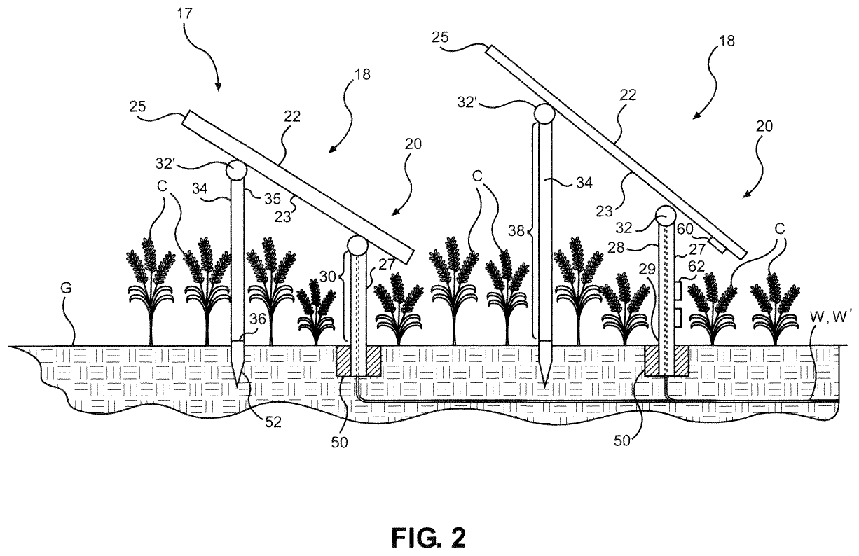

The exemplary system 17 of the invention illustrated in FIGS. 2-4 overcomes disadvantages of the system 10 of FIG. 1. This is primarily accomplished by configuring the solar panel mechanisms shown generally by reference numerals 18 so that the solar panels 20 of the mechanisms 18 may be moved out of the way longitudinally so that agricultural equipment may travel over the ground G without requiring the large spacing between the panels 12 illustrated in FIG. 1. Thereby crops C can be grown beneath the panels 20. However, if desired, the panels 20 can still be spaced as in FIG. 1 so that crops may be treated or harvested not only underneath and adjacent the panels 20 but in the rows between the panels.

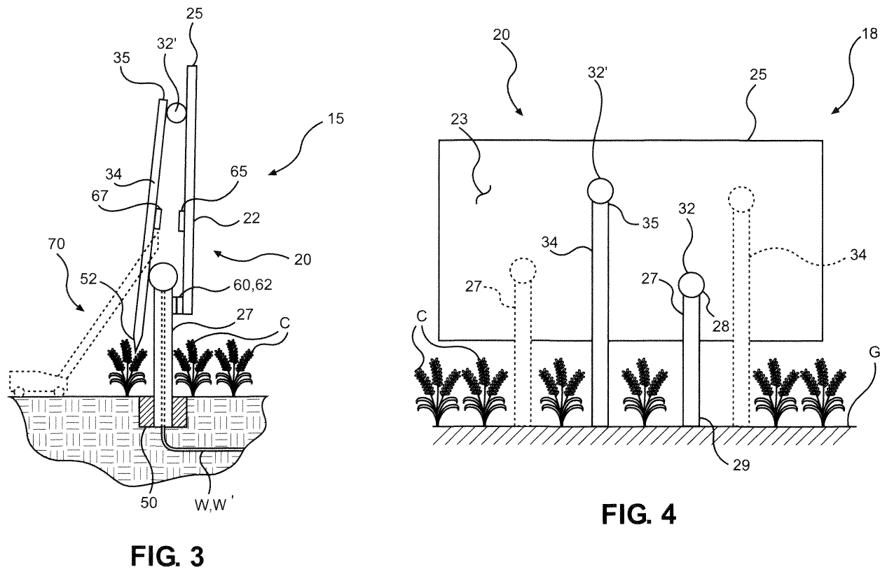

The advantages of the exemplary system 17 according to the invention are primarily achieved by providing the front and rear supports for the solar panel mechanisms 18 so that they are readily movable from a use position (FIGS. 2 and 4) where the solar panels 20 of the panel mechanisms 18 capture usable thermal and/or radiant energy from the sun, to an out-of-the-way collapsed position (FIG. 3) where the panels 20 are substantially vertical. The term “substantially vertical” means that the panels 20 are out of the way of agricultural machinery movable between the mechanisms 18; typically this means the panels 20 are either precisely vertical or +/− about 1-10° from vertical.

The solar panels 20 can be thermal (which recover the sun's heat for useful purposes and can use either liquid, gas, or some other medium to effectively utilize the thermal energy recovered), photovoltaic (which covers all types of cells in panels including, but not limited to, monocrystalline silicon, polycrystalline silicon, thin film, perovskite, organic, and quantum dots), and/or hybrid (a combination of thermal and photovoltaic). The solar panels 20 also can have any desired configuration including translucent, transparent, semi-transparent, and opaque, and may be rigid or flexible.

The solar panel 20 of each mechanism 18 has a first major surface 22 which faces the sun (in use) and recovers energy therefrom, a second major surface 23 opposite the first surface 22; and an elongated top edge 25 typically substantially horizontal in use. A first support structure 27 supports the front end of the panel 20 in use; the structure 27 has opposite first 28 and second 29 ends, and has a first operative length 30 (above the ground G). A first pivotal connection 32 is operatively provided between the first support structure 27 first end 28 and the panel second major surface 23.

The mechanism 18 also includes a second support structure 34 having opposite first 35 and second 36 ends, and has a second operative length 38 greater than the first operative length 30. A second pivotal connection 32′ (which can be the same as or different than the pivotal connection 32 between elements 27 and 23) is provided between the second support structure 34 first end 35 and the panel second major surface 23. As seen in each of FIGS. 2-4 the second pivotal connection 32′ is closer to the top edge 25 than is the first pivotal connection 32.

While in the drawings only one each of the first and second support structures 27, 34 are illustrated in solid line and the mechanism 18 may consist of only one each of the structures 27, 34, it is to be understood that any number of structures 27, 34 may be provided in order to properly support a given panel 20 depending on the construction and dimensions of the panel 20. For example a second set of structures 27, 34 is illustrated in dotted line in FIG. 4.

Also, one or both of the support structures 27, 34 can be made adjustable so that the tilt of the solar panel when in the position illustrated in FIGS. 2 & 4 can be changed to optimize energy recovery. For example the support structures 27, 34 can have telescoping components which can be moved with respect to each other manually or by a powered mechanism.

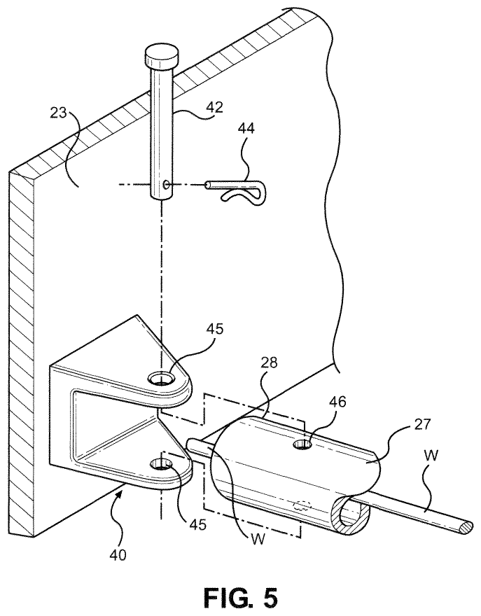

The pivotal connections 32, 32′ can have any effective conventional construction. For example they may have the configurations such as shown in U S Patent Publication 2015/345545 or GB 1096733. However, especially when the panel 20 is a photovoltaic or hybrid panel, the configuration of FIG. 5 may be utilized, which construction is similar to that shown in U.S. Pat. No. 9,181,723. That is the pivotal connection 32, 32′ comprises a tubular configuration of the support structure 27, a clevis 40 operatively connected (e g. by adhesive or fasteners) to the panel second surface 23, and a pivot pin 42 extending between the clevis 40 and the first end 28 of the tubular first support structure 27. A conventional cotter pin 44 may be used to hold the pivot pin 42 in place when it extends through the aligned openings 45 in the clevis 40 and 46 in the support structure first end 28. The tubular configuration of the structure 27 allows a conventional electrical wire, shown only partially and schematically at W in FIG. 5, to extend from the photovoltaic cells of the panel 20 through the structure 27 to be connected to other wires from other panels 20, e. g. underground as illustrated by the wire W′ seen in FIGS. 2 & 3.

Desirably the length 38 is at least about 10% (e. g. about 15-50%) greater than the length 30 is, and the distance of the pivotal connection 32′ is at least about 10% closer (e. g. about 15-50%) to the top edge 25 than is the pivotal connection 32.

The second end 29 of the structure 27 is typically essentially permanently mounted in the ground G such as shown schematically by the conventional concrete footing 50 seen in FIGS. 2 & 3. The second end 36 of the structure 34, on the other hand, is readily removably mounted in the ground G or otherwise supported by the ground G, seen so mounted in FIGS. 2 and 4 but shown removed in FIG. 3. That is when the second end 36 is secured in, on, or to the ground G the mechanism 18 is positively held in place in response to environmental conditions. However, when it is desired to treat, harvest, or re-plant the crops C with agricultural machinery one pivots the panel 20 out of the way—as illustrated in FIG. 3—the end 26 may be readily removed from being supported by the ground G. This may be accomplished by any conventional means, such as by providing the end 28 to be in the form of a spike 52 as illustrated in FIGS. 2 & 3, which penetrates the ground G. Alternatively the end 28 may be in the form of an apertured plate with spikes driven through the apertures to hold the plate in contact with the ground G, but allowing ready removal, or in some cases the support 34 may be held in place primarily or exclusively by weight.

In order to accommodate the movement of a panel 20 from the use position of FIGS. 2 and 4 to the out-of-the-way position in FIG. 3 the first and second pivotal connections 32, 32′ are offset from each other in the dimension of elongation of the top edge 25 as clearly illustrated in FIG. 4.

Each mechanism 18 also preferably includes first and second latch elements shown schematically at 60, 62, respectively in FIGS. 2 & 3. The first latch element 60 is operatively connected to the panel second surface 23 further from the top edge 25 than is the first pivotal connection 32. The second latch element 62 is operatively connected to the first support structure 27 in cooperating relationship with the first latch element 60 when the panel 20 is moved to the substantially vertical, out-of-the-way, position illustrated in FIG. 3.

For convenience the latch elements 60, 62 are shown only schematically in the drawings as conventional cooperating magnetic elements. However any type of mechanical latch element may alternatively or in addition be provided, such as cam, compression, draw, sliding, spring-loaded, slam, or the like mechanical latch elements. The latch elements 60, 62, where necessary, maintain the panel 20 in the substantially vertical position of FIG. 3 until released.

If it is desirable or necessary to keep the second support structure 34 out-of-the-way in the FIG. 3 position then a second set of latch elements 65, 67 (the same as or different than the elements 60, 62) may be provided. The element 65 of the second set of latch elements is connected to the rear major surface 23 of the panel 20 as schematically illustrated in FIG. 3, while the cooperating element 67 of the second set is mounted to the support element 34 in a cooperating relationship. The latch elements 65, 67 are shown slightly spaced in FIG. 3 for clarity of illustration but they mesh when functioning to latch the support structure 34 in place.

The invention also relates to a method of providing and operating an agrisolar or agrivoltaic system as described above. The method comprises (or consists of): a) mounting the second support structure 30 second end 36 so that it is removably supported by the ground G so that the system 17 is stable under normal environmental conditions; and b) occasionally (e. g. manually although powered equipment can be designed for that purpose) removing the second end 36 of the second support structure 34 from support by the ground G and then moving the second support structure 34 upwardly so that the panel 20 is moved to the substantially vertical position of FIG. 3. Typically b) is practiced when it is desirable to treat or harvest or re-plant the crops C using agricultural machinery. In that case the method further comprises c) running agricultural machinery to treat or harvest or re-plant the crops after the practice of b) when the panels are in a substantially vertical position. After treatment or harvesting (or subsequent planting) the method may further comprise d) returning the second support structure 34 to the solar energy capturing position illustrated in FIGS. 2 & 4.

In performing the method, procedure b) may be practiced at least in part by operatively connecting a hydraulic or pneumatic jack-shown schematically in dotted line at 70 in FIG. 3—to the second support structure 34 and operating the jack 70 to move the second support structure 34 from the position illustrated in FIGS. 2 & 4 to that illustrated in FIG. 3. The jack 70 can also be used to assist in, or actually effectuate, detachment of the second support structure 34 from the ground G, or the removal can be effectuated without assistance from the jack 70.

While the invention has been illustrated and described in what is presently conceived to be the most practical and preferred embodiments thereof it is to be understood that the invention is to be accorded the broadest interpretation of the appended clams to encompass all equivalent mechanisms, systems, and methods, which claims are to be limited only by the prior art.

Additionally, all ranges encompass each and every individual range within a broad range. For example about 15-50% includes 19-32%, 30-45%, and all other narrow ranges within the broad range.

What is claimed is:

1. A solar mechanism comprising:
a solar panel having a first major surface for facing the sun and recovering energy therefrom, a second major surface opposite said first surface; and an elongated top edge in;
a first support structure having opposite first and second ends, and having a first operative length;
a first pivotal connection between said first support structure first end and said panel second major surface:
a second support structure having opposite first and second ends and having a second operative length greater than said first operative length;
a second pivotal connection between said second support structure first end and said panel second major surface; and
wherein said second pivotal connection is closer to said top edge than said first pivotal connection is.

2. A mechanism as recited in claim 1 wherein said first and second pivotal connections are offset from each other in the dimension of elongation of said top edge.

3. A mechanism as recited in claim 1 further comprising first and second latch elements; said first latch element operatively connected to said panel second surface further from said top edge than said first pivotal connection; and said second latch element operatively connected to said first support structure in cooperating relationship with said first latch element when said solar panel is moved to a substantially vertical position.

4. A mechanism as recited in claim 1 further comprising a ground-penetrating and manually removable element at said second support structure second end.

5. A mechanism as recited in claim 1 wherein said first support structure is tubular and wherein said first pivotal connection comprises a clevis operatively connected to said panel and a pivot pin extending between said clevis and said first end of said tubular first support structure.

6. A mechanism as recited in claim 1 wherein said solar panel comprises a photovoltaic or hybrid panel.

7. A mechanism as recited in claim 1 wherein said first support structure second end is substantially permanently buried in the ground so that only said first operative length thereof extends out of the ground; and wherein said second operative length is at least about 10% longer than said first operative length; and wherein said first pivotal connection is spaced at least about 10% further from said top edge than said second pivotal connection.

8. A mechanism as recited in claim 7 further comprising a ground-penetrating and manually removable spike at said second support structure second end.

9. A mechanism as recited in claim 3 further comprising a second set of latch elements between said second support structure and said second major surface of said panel for holding said second support structure in combination with said solar panel when said solar panel is in a substantially vertical position.

10. An agrisolar or agrivoltaic system comprising:
a solar panel having a first major surface facing the sun, a second major surface opposite said first surface, and an elongated substantially horizontal top edge;
a first support structure having opposite first and second ends, and having a first operative length;
said second end of said first support structure substantially permanently mounted in the ground so that only said first operative length thereof extends above the ground;
a first pivotal connection between said first support structure first end and said solar panel second major surface:
a second support structure having opposite first and second ends and having a second operative length greater than said first operative length;
a second pivotal connection between said second support structure first end and said solar panel second major surface;
said second support structure removably operatively mounted by or in the ground;
said second pivotal connection closer to said top edge than said first pivotal connection so that when said second support structure second end is moved upwardly said first and second support structures pivot about said first and second pivotal connections so that said solar panel moves to a substantially vertical orientation; and.
crops in the ground beneath said solar panel when said second support structure second end is operatively mounted by or in the ground.

11. A system as recited in claim 10 further comprising first and second latch elements; said first latch element operatively connected to said panel second surface further from said top edge than said first pivotal connection; and said second latch element operatively connected to said first support structure in cooperating relationship with said first latch element so that when said second support structure second end is disconnected from the ground and said first and second support structures pivot about said first and second pivotal connections and said panel is moved to a substantially vertical position said first and second latch elements mate to releasably retain said panel in said substantially vertical position.

12. A system as recited in claim 11 further comprising a second set of latch elements between said second support structure and said second major surface of said panel for holding said second support structure in combination with said panel when said panel is in a substantially vertical position.

13. A system as recited in claim 10 wherein said first support structure is tubular and wherein said first pivotal connection comprises a clevis operatively connected to said solar panel and a pivot pin extending between said clevis and said first end of said tubular first support structure; and wherein said solar panel comprises a photovoltaic or hybrid panel.

14. A system as recited in claim 13 further comprising an electrical wire extending from said solar panel through said tubular first support element.

15. A system as recited in claim 10 wherein said first and second pivotal connections are horizontally offset from each other.

16. A system as recited in claim 11 wherein said latch elements are magnetic latch elements.

17. A method of providing and operating an agrisolar or agrivoltaic system as recited in claim 10 comprising:
a) mounting said second support structure second end so that it is removably mounted by or in the ground so that the system is stable under normal environmental conditions; and
b) occasionally removing said second end of said second support structure from being supported by the ground and then moving said second support structure upwardly so that said panel is moved to a substantially vertical position.

18. A method as recited in claim 17 wherein b) is practiced at least in part by operatively connecting a hydraulic or pneumatic jack to said second support structure and operating the jack.

19. A method as recited in claim 17 further comprising c) running agricultural machinery to treat or harvest or re-plant the crops after the practice of b) when the panels are in a substantially vertical position.

20. A method of providing and operating an agrisolar or agrivoltaic system as recited in claim 11 comprising:
a) mounting said second support structure second end so that it is removably mounted by or in the ground so that the system is stable under normal environmental conditions; and
b) occasionally removing said second end of said second support structure from being supported by the ground and then moving said second support structure upwardly so that said panel is moved to a substantially vertical position and is releasably held in that position by said latch elements.
